(19) United States
(12) Patent Application Publication
(10) Pub. No.: US 2007/0073787 A1
(43) Pub. Date: Mar. 29, 2007

(54) Method and apparatus for synchronizing databases connected by wireless interface

(75) Inventors: Piotr K. Tysowski, Waterloo (CA); Michael T. Hardy, Waterloo (CA); Barry Linkert, Petersburg (CA)

Correspondence Address: Geoffrey B.C. deKleine;PERRY + PARTNERS, Suite 500, 1300 Yonge Steet, Toronto, ON, M4T 1X3, CA

(73) Assignee: RESEARCH IN MOTION LIMITED

(21) Appl. No.: 11/452,907

(22) Filed: Jun. 15, 2006

Related U.S. Application Data
(60) Provisional application No. 60/721,534, filed on Sep. 29, 2005.

(51) Int. Cl. G06F 17/30

(52) U.S. Cl. 707/201

(57) ABSTRACT

A method of synchronizing a first database including first data records with a second database including second data records includes receiving information representative of the second data records and modifying the first data records of the first database in a unidirectional synchronization with the second data records of the second database including deleting ones of the first data records present in the first database for which there is no corresponding second data record present in the second database.

### CROSS-REFERENCE TO RELATED APPLICATIONS

This application claims the benefit of U.S. Provisional Application No. 60/721,534, filed Sep. 29, 2005.

### FIELD

The present application relates generally to portable electronic devices and more particularly to the synchronizing of data at a portable electronic device with data embodied at a communication network.

### BACKGROUND

Portable electronic devices such as wireless personal digital assistants (PDAs), smart telephones and laptop computers with wireless capabilities have gained widespread use for a variety of functions. Such devices are commonly used for communication purposes including transportation of data, and run on a wide variety of networks from data-only networks such as Mobitex and DataTAC to complex voice and data networks such as GSM/GPRS, CDMA, EDGE, UMTS AND W-CDMA networks.

These portable electronic devices commonly include databases for storing data that is selectably retrievable by a user of a device. The data forms a series of data records, each data record containing one or more fields. During operation of the device, the data is retrieved and displayed, or otherwise made available to the user. The data can be modified, added to or deleted by the user of the device.

Advances in data storage have accompanied advances in portable electronic devices, to provide for back-up of data stored at the electronic device. By backing-up the device, data can be recovered in the event of data loss at the electronic device. Various electronic devices are backed-up by way of communication over a fixed (wire) connection between the electronic device and, for example, a computing station such as a desktop computer. Once the data is stored in a database at the computing station, the stored data can be modified, added to or deleted by a user at the computing station.

Other portable electronic devices provide for back-up of data stored thereon, to a computing station by way of a radio interface, using, for example, the networks listed above. Thus, data is sent over a radio communication channel of a radio communication system, thereby forming a communications link between the portable electronic device and a remote station (a station not linked by wire communication). Again, once the data is stored in a database at a computing station, the stored data can be modified, added to or deleted at the computing station. Thus, while data stored in the database of the portable electronic device is backed-up to a computing station, data is also transmitted from the computing station to the portable electronic device to synchronize the databases of the portable electronic device with the databases of the computing station. When a data record on a computing station does not exist on the portable electronic device, or when the content of the data record (the fields of the data record) of the computing station differs from the content of the data record of the portable electronic device, then the additional data record or differing data record is transferred to the portable electronic device. Similarly, when a data record on a portable electronic device does not exist on the computing station, or when the content of the data record of the portable electronic device differs from the content of the data record of the computing station, the additional data record or differing data record is transferred to the computing station.

Data synchronization over a radio communication channel is clearly advantageous as data can be communicated remotely over large distances. Conventional manners of data synchronization over radio communication channels suffer disadvantages, however. Such data synchronization can be prohibitively bandwidth consumptive. If many records are transferred, the transfer time can be extensive meaning that a communication channel is opened for a long period of time to transfer the data records, which can be costly.

When a data record is deleted from the portable electronic device, a delete data record indication is sent from the portable electronic device to the computing station in order to delete the corresponding data record at the computing station. When many records are deleted during operation of the portable electronic device, the portable electronic device transmits several delete data record indications (one data record delete indication for each data record deleted on the portable electronic device), requiring further transfer time and bandwidth. Thus, while deletion of data records does not require transfer of the full data record, a delete data record indication must be sent for each record deleted.

Improvements in synchronizing databases connected by wireless interface are therefore desirable.

### BRIEF DESCRIPTION OF THE DRAWINGS

The method and apparatus for synchronizing databases connected by wireless interface will be better understood with reference to the following description and to the Figures, in which:

FIG. 1 is a functional block diagram of a radio communication system and portable electronic device;

FIG. 2 is a block diagram of certain internal components within the portable electronic device;

FIG. 3 is a block diagram of certain internal components within a synchronization server;

FIG. 4 is a sequence diagram illustrating functions carried out at both the portable electronic device and the communication system during synchronization of databases connected by wireless interface;

FIGS. 5A and 5B are sequence diagrams illustrating functions carried out at both the portable electronic device and the communication system during updating of databases;

FIG. 6 is a sequence diagram illustrating functions carried out at both the portable electronic device and the communication system when data records are deleted from the portable electronic device;

FIG. 7 is a sequence diagram illustrating functions carried out at both the portable electronic device and the communication system during special synchronization of databases connected by wireless interface;

FIG. 8 is a sequence diagram illustrating functions carried out at both the communication system and the portable electronic device when data records are deleted from the communication system; and

FIG. 9 is a sequence diagram illustrating functions carried out at both the communication system and the portable electronic device during a second special synchronization of databases connected by wireless interface;

### DETAILED DESCRIPTION OF THE EMBODIMENTS

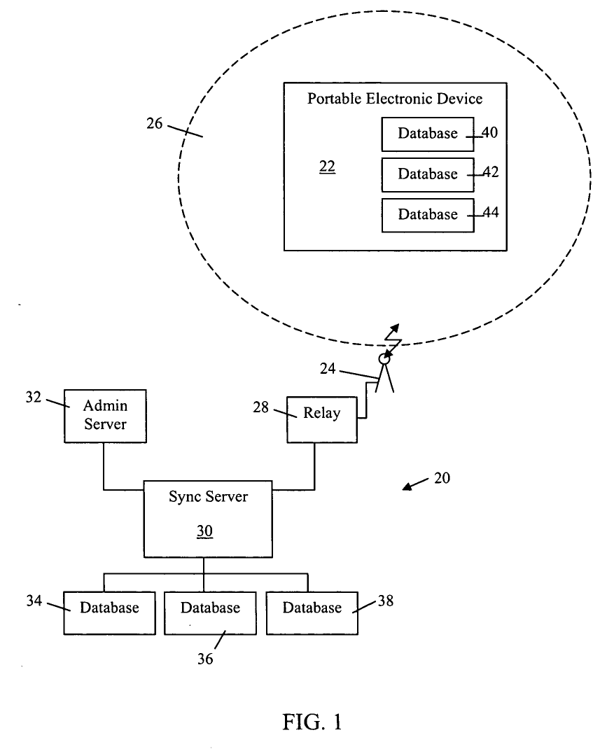

Reference is first made to FIG. 1 which shows a functional block diagram of a radio communication system indicated generally by the numeral 20 and a portable electronic device 22. The radio communication system 20 provides for communications with portable electronic devices including the exemplary portable electronic device 22, as shown. The portable electronic device 22 and the radio communication system 20 are operable to effect communications over a radio communications channel therebetween. Data originating at the portable electronic device 22 is communicated to the radio communication system 20 by way of the radio communications channel. Similarly, data originating at the communication system 20 is communicated from the radio communication system 20 to the portable electronic device 22 by way of the radio communications channel, thereby providing data to the portable electronic device 22.

For the purpose of illustration, the communications system is functionally represented in FIG. 1 and a single base station 24 is shown. The base station 24 defines a coverage area, or cell 26 within which communications between the base station 24 and the portable electronic device 22 can be effected. It will be appreciated that the portable electronic device 22 is movable within the cell 26 and can be moved to coverage areas defined by other cells that are not illustrated in the present example. The communication system 20 includes a relay device 28 that is connected to the base station 24 and a synchronization server 30. It will be understood that the functions provided by the relay device 28 and the synchronization server 30 can be embodied in the same device. The synchronization server 30 is connected to an administration server 32, as shown. The administration server 32 provides administrative services to the communications system 20 and, for instance, provides administrative control over the synchronization server 30.

The synchronization server 30 is functionally coupled to databases, of which, three exemplary database types including a first database 34, a second database 36 and a third database 38, are shown. The databases of the present example are of a text format such as an Extensible Mark-up Language (XML) format. The data maintained in the first, second and third databases 34, 36, 38, includes a number of data records, each data record containing a-plurality of fields that are populated with data. Particular ones of the fields of each data record that are populated are key fields that are sufficient to uniquely identify the data record in which they are contained.

The portable electronic device 22, of which only particular functional portions are shown in FIG. 1 for the purposes of the present description, includes a plurality of databases 40, 42, 44 that correspond to the first, second and third databases 34, 36, 38, respectively, of the communication system 20. The databases 34, 36, 38 and the databases 40, 42, 44, can be selectably altered in an asymmetrical manner such that the databases 34, 36, 38 of the communication system 20 do not match the databases 40, 42, 44 of the portable electronic device 22. In other words, any or all of the databases 34, 36, 38, 40, 42, 44 can be altered by adding records, deleting records and modifying fields of the records by adding, deleting or modifying the data populating those fields.

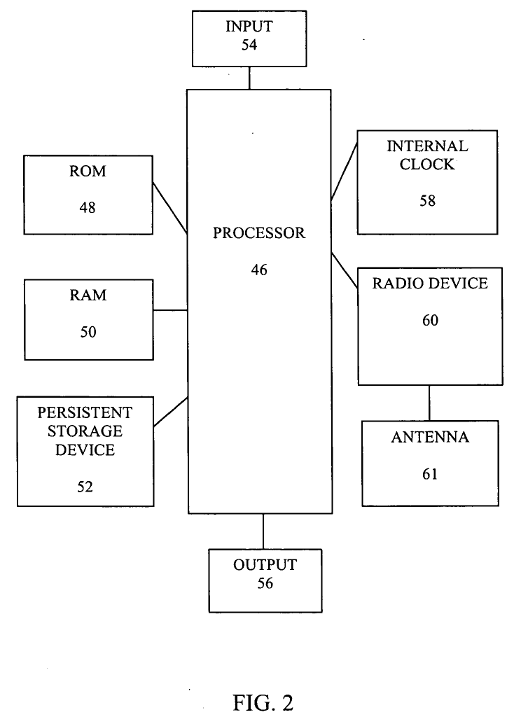

Reference is now made to FIG. 2 which shows a block diagram of certain internal components within the portable electronic device 22. The portable electronic device 22 is based on a microcomputer that includes a processor 46 connected to a read-only-memory (ROM) 48 that contains a plurality of applications executable by the processor 46 to enable the portable electronic device 22 to perform certain functions including synchronization with the communication system 20. The processor 46 is also connected to a random access memory unit (RAM) 50 and a persistent storage device 52 which are responsible for various non-volatile storage functions of the portable electronic device 22 and in which the databases 40, 42, 44 are maintained. The processor 46 receives input from input devices 54 such as a keyboard. The processor 46 outputs to output devices 56 such as an LCD display. The processor 46 is also connected to an internal clock 58 and a radio device 60 which in turn is connected to an antenna 61. Together the radio device 60 and the antenna 61 are used to connect to the radio communication system 20 over a radio communications channel. Thus, the portable electronic device 22 is operable to receive and transmit communication signals containing data that is communicated to and from the communication system 20 via the radio device 60 and the antenna 61.

It will be understood that the functions described herein can be carried out in any suitable manner. In the present example, the functions are carried out by algorithms executable by the processor 46 in a synchronization application. For example, the processor 46 of the portable electronic device 22 is operable to perform hash functions by retrieving the data from one or more of the databases 40, 42, 44 of the persistent storage device 52 and generating a hash, thereby placing the accessed data in short-digest form. Hash functions performed by the processor 46 include, for example, computation of check sums as well as other hash function computations. The processor 46 is further operable to provide the generated hash to the radio device 60 for transmission from the portable electronic device 22 to the radio communication system 20 over the radio communications channel. In particular, the processor 46 is operable to generate a database hash including information representative of a database 40, 42, 44. Database hash generation is triggered by the detection of an event at the portable electronic device 22, by input from the input device 54 or by a signal received from communication system 20.

The microcomputer of the portable electronic device 22 is operable to receive communications from the communication system 20. For example, the microcomputer is operable to receive a request for record hash information and in response, to provide record hash information by retrieving data from one or more of the databases 40, 42, 44, performing hash functions on the data, thereby generating a record hash and transmitting the record hash to the communication system 20. The microcomputer is further operable to receive a request for data records which, in response to such a request, the data records are retrieved from one or more the databases 40, 42, 44 and transmitted to the communication system 20. Further still, the microcomputer is operable to receive data transmitted from the communication system 20 and to write the data by adding the data to one or more of the databases 40, 42, 44 or overwriting data on one or more of the databases 40, 42, 44, maintained on the persistent storage device 52. The microcomputer is also operable to delete data from one or more of the databases 40, 42, 44, in response to receipt of a user input or an indication from the communication system 20, for example. The microcomputer is further operable to determine a number of data records for deleting in accordance with a delete data records command received from a user input, for example and to compare this number to a threshold number. Based on the results of this comparison, the microcomputer is operable to either send individual delete data record commands to the communication system 20 for each data record deleted or to trigger a special synchronization as described hereinbelow.

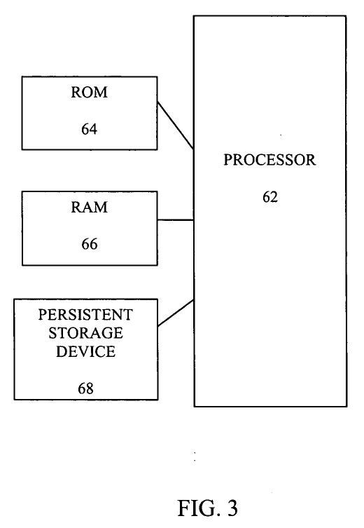

Reference is now made to FIG. 3 which shows a block diagram of certain internal components within the synchronization server 30. Similar to the portable electronic device 22, the synchronization server 30 includes a processor 62 connected to a read only memory (ROM) 64 that includes applications executable by the processor 62 and enables the synchronization server 30 to perform certain functions including synchronization with the portable electronic device 22. The processor 62 is also connected to a random access memory unit (RAM) 66 and a persistent storage device 68 which are responsible for various non-volatile storage functions of the synchronization server 30. The processor 62 is connected to the databases 34, 36, 38 and to the relay device 28, which in turn is connected to the base station 24 for connecting to the portable electronic device 22 over a radio communications channel. Thus, the synchronization server 30 is operable to receive and transmit communication signals containing data that is communicated to and from the portable electronic device 22 via the relay device 28 and the base station 24.

Again, it will be understood that the functions described herein can be carried out in any suitable manner. In the present example, the functions are carried out by algorithms executable by the processor 62. For example, the processor 62 of the synchronization server 30 is operable to perform hash functions by retrieving the data from one or more of the databases 34, 36, 38 and generating a hash, thereby placing the accessed data in short-digest form. In particular, the processor 62 is operable to generate a database hash including information representative of a databases 34, 36, 38.

The synchronization server 30 is operable to receive communications generated by the portable electronic device 22 relating to synchronization. For example, the synchronization server 30 is operable to receive the database hash generated by the portable electronic device 22 and, in response, to compare the database hash information from this database hash to the database hash information from the locally generated database hash, generated by the synchronization server 30. The synchronization server 30 is also operable to request record hash information from the portable electronic device 22, based on and in response to results of the comparison of the database hash information from the database hash generated by the portable electronic device 22 with the database hash information from the locally generated database hash. The request for record hash information is provided to the relay 28 and, through the base station 24, is transmitted to the portable electronic device 22. The synchronization server 30 is operable to receive the record hash information generated by the portable electronic device 22 and, in response, to compare the record hash information to record hash information from the locally generated record hash, generated by the synchronization server 30.

The synchronization server 30 is further operable to request data records from the portable electronic device 22, based on and in response to results of a comparison of the record hash information from the record hash generated by the portable electronic device 22 with the record hash information from the locally generated record hash. The request for data records is provided to the relay 28 and, through the base station 24, is transmitted to the portable electronic device 22. Further still, the synchronization server 30 is operable to receive data transmitted from the portable electronic device 22 (through the base station 24 and relay device 28) and to write the data by adding the data to one or more of the databases 34, 36, 38 or by overwriting the data on one or more of the databases 34, 36, 38. The synchronization server 30 is also operable to delete data from one ore more of the databases 34, 36, 38, in response to receipt of an input or an indication from the portable electronic device 22, for example. The synchronization server 30 is further operable to determine a number of data records for deleting in accordance with a delete data records command received from an input device, for example and to compare this number to a threshold number. Based on the results of this comparison, the synchronization server 30 is operable to either send individual delete data record commands to the portable electronic device 22 for each data record deleted or to trigger a second special synchronization as described hereinbelow.

Further still, the synchronization server 30 stores synchronization history data in the persistent storage device 68, thereby maintaining a listing of changes made to the databases 34, 36, 38 connected to the synchronization server 30 and to the databases 40, 42, 44 of the portable electronic device 22. The synchronization server 30 accesses the synchronization history data during synchronization operations to reduce the data communicated between the communication system 20 and the portable electronic device 22 in subsequent synchronizations by determining previously synchronized data.

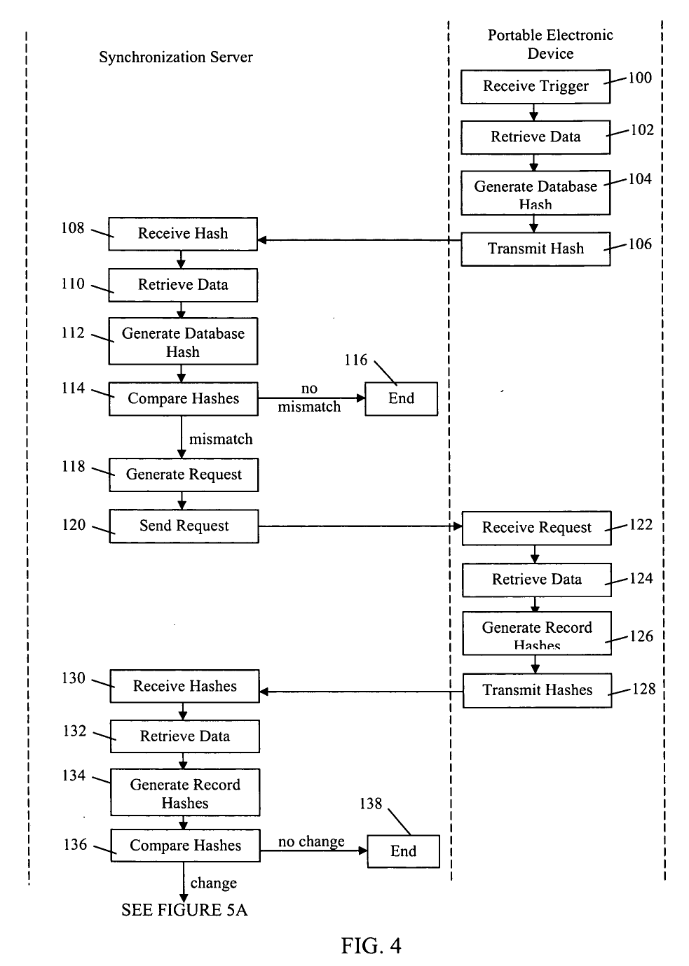

Reference is now made to FIG. 4, which shows a sequence diagram illustrating functions carried out at both the portable electronic device 22 and the communication system 20 during synchronization of databases connected by wireless interface, in accordance with one embodiment of the present application. Coding of software for carrying out such steps is well within the scope of a person of ordinary skill in the art. First, the portable electronic device 22 receives a synchronization trigger at 100, from, for example, a user input on the input device 54. Alternatively, the portable electronic device 22 receives a synchronization trigger from the communication system 20. In response to receipt of the synchronization trigger, data is retrieved from the databases 40, 42, 44 at step 102 and the processor 46 generates a database hash for each database 40, 42, 44 at step 104. After generation of each database hash, each database hash is transmitted along with an initialize command at step 106 to the communication system 20 over a radio communication channel. The initialize command triggers the synchronization process at the synchronization server 30.

The communication system 20 receives the initialize command along with each database hash at step 108 by receipt at the base station 24 and forwards the database hashes on to the synchronization server 30. In response to receipt of each database hash from the portable electronic device 22, data is retrieved from the databases 34, 36, 38 at step 110 and the processor 62 of the synchronization server 30 generates a database hash for each respective database (referred to herein as the locally generated database hash) at step 112. After generation of each locally generated database hash, the hash information of each database hash received from the portable electronic device 22 is compared with the hash information of the corresponding locally generated database hash at step 114. If the comparison of the hash information indicates that the databases 40, 42, 44 of the portable electronic device 22 are not in mismatch with the respective databases 34, 36, 38 of the communication system 20, then the synchronization process ends at step 116. If, however, the comparison of the hash information indicates that any one of the databases 40, 42, 44 of the portable electronic device 22 are in mismatch with the respective databases, 34, 36, 38 of the communication system 20, then at least one of the databases is to be updated and a request for record hash information is generated by the synchronization server 30 at step 118. The request for record hash information is a request for record hash information associated with data records. The record hash information is requested for each data record of a particular database of the portable electronic device 22 that is determined to be mismatched with the corresponding database of the communication system 20. After generation of the request for record hash information, the request is then transmitted at step 120 to the portable electronic device 22.

Once the request for record hash information is received at the portable electronic device 22 at step 122, data is retrieved from one or more of the databases 40, 42, 44 at step 124, in accordance with the request for record hash information. A record hash is then generated at step 126 for each of the data records of the respective database, and each record hash is transmitted at step 128 to the communication system 20 over the radio communication channel.

The record hash information is received at the communication system 20 and delivered to the synchronization server 30 at step 130. In response to receipt of the requested record hash information, the data is retrieved from one or more of the corresponding databases 34, 36, 38 at step 132 and a record hash (referred to as the locally generated record hash) is generated for each of the corresponding data records of the respective database at step 134. After generation of each locally generated record hash, the record hash information received from the portable electronic device 22 is compared with the record hash information from each locally generated record hash at step 136 and a determination is made as to whether the data, of which the record hash information is representative, has changed. If it is determined that this data has not changed, the synchronization process ends for the particular data record for which the data has not changed at step 138. If, however, it is determined that this data has changed, the comparison at step 136 also determines what, if any, additional or changed data records at the communication system 20 are not reflected at the portable electronic device 22 and what, if any, additional or changed data records at the portable electronic device 20 are not reflected at the communication system 20. Thus, if it is determined that the data has changed at step 136, the databases are synchronized by updating the databases at communication system 20 or the portable electronic device 22 or databases at both the communication system 20 and the portable electronic device 22 that are determined to be mismatched. With the determination of a mismatch, a conflict resolution policy is run, thereby determining how the mismatched records are to be updated (i.e. whether to update the database records on the portable electronic device 22 with the database records of the synchronization server 30, to update the database records of the synchronization server 30 with the database records on the portable electronic device 22, or to update both).

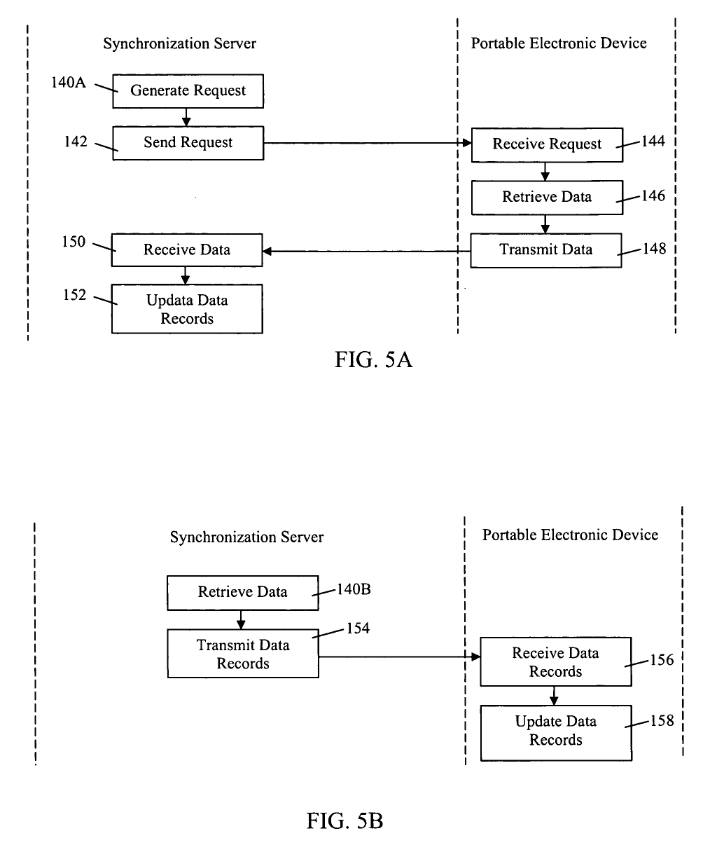

Referring now to FIG. 5A, there is shown a sequence diagram illustrating functions carried out at both the portable electronic device 22 and the communication system 20 during updating of the databases 34, 36, 38 of the communication system 20. Again, coding of software for carrying out such steps is well within the scope of a person of ordinary skill in the art. If it is determined at step 136 that additional data records or changes to data records at the portable electronic device 20 are not yet reflected at the communication system 20, a fetch request is generated by the synchronization server 30 as shown at step 140A. After generation of the fetch request, the fetch request is transmitted to the portable electronic device 22 at step 142, thereby requesting data records added and changed on the portable electronic device 22 that have not been updated on the synchronization server 30.

The fetch request is then received at the portable electronic device 22 at step 144 and in response, the requested data records are retrieved from the databases 40, 42, 44 at step 146. After retrieving the data records, the retrieved data records are transmitted to the communication system 20 at step 148.

The requested data records are then received at the communication system 20 and delivered to the synchronization server 30 at step 150. In response to receipt of the requested data records, the respective ones of the databases 34, 36, 38 of the communication system 20 are updated by writing new data records or overwriting to update previously saved data records in the respective databases 34, 36, 38. It will be understood that data records retrieved from one database of the portable electronic device 20 and transmitted to the communication device 20, are written to or overwritten on to the corresponding database of the communication system 20.

Referring now to FIG. 5B, there is shown a sequence diagram illustrating functions carried out at both the portable electronic device 22 and the communication system 20 during updating of the databases 40, 42, 44 at the portable electronic device 22. Yet again, coding of software for carrying out such steps is well within the scope of a person of ordinary skill in the art.

If it is determined at step 136 that additional data records or changes to data records at the communication system 20 are not reflected at the portable electronic device 20, the data records that have been added or changed on the synchronization server 30 that have not been updated on the portable electronic device 22 are retrieved at step 140B. These data records are then transmitted to the portable electronic device 22 at step 154.

The portable electronic device 22 receives the data records at step 156 and updates the data records at step 158 by writing the new data record or overwriting to update the previously saved data record in the respective database 40, 42, 44. Again it will be understood that the data records retrieved from one database of the communication system 20 and transmitted to the portable electronic device 22, are written to or overwritten on the corresponding database of the portable electronic device 22.

It will be appreciated from the above description that data records determined to be present in the databases 34, 36, 38 of the communication system 20 that are not present in the databases 40, 42, 44 at the portable electronic device 22, are transferred to the portable electronic device at step 154 and are stored in the respective database of the portable electronic device 22. Similarly, data records determined to be present in the databases 40, 42, 44 of the portable electronic device 22 that are not present in the databases 34, 36, 38 of the communication system 20, are transferred to the communication system 20 at step 148 and stored in the respective databases 34, 36, 38 of the communication system 20 at step 152.

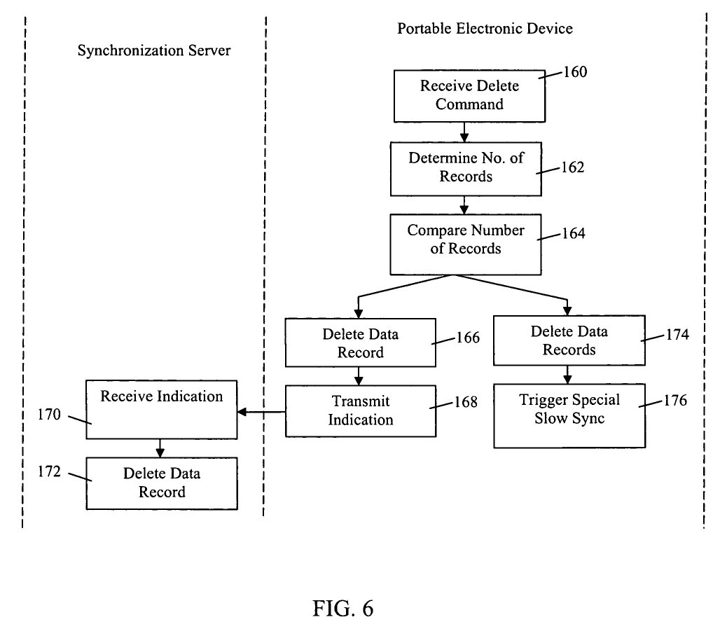

Reference is now made to FIG. 6 which shows a sequence diagram illustrating functions carried out at both the portable electronic device 22 and the communication system 20 when data records are deleted from the portable electronic device 22. Coding of software for carrying out such steps is well within the scope of a person of ordinary skill in the art. First, the portable electronic device 22 receives a delete data records command, from a user input on the input device 54, at step 160. After receiving the delete data records command, the processor 46 determines the number of data records to which the delete data records command relates at step 162. In other words, the processor 46 determines the number of data records to be deleted. Next the processor 46 compares the number of data records to which the delete data records command relates to a predetermined threshold value at step 164. If the number of data records to which the delete data records command relates is less than the threshold value, the data records to which the command relates are deleted from the database (or databases) 40, 42, 44 to which the data records belong at step 166 and a delete data record indication is transmitted to the communication system 20 at step 168, for each data record deleted. Thus, for every data record deleted from the databases 40, 42, 44, a corresponding delete data record indication is transmitted to the communication system 20.

The communication system 20 receives the delete data record indications at step 170 and deletes the respective data records from the respective database 34, 36, 38 at step 172.

If, on the other hand, the number of data records to which the delete data records command relates is greater than the threshold value, the data records to which the delete data records command relates are deleted from the database (or databases) 40, 42, 44 to which the data records belong at step 174 and the portable electronic device 22 triggers a special synchronization process at step 176 in which the databases 34, 36, 38 of the communication system 20 are updated to mirror the databases 40, 42, 44 of the portable electronic device 22.

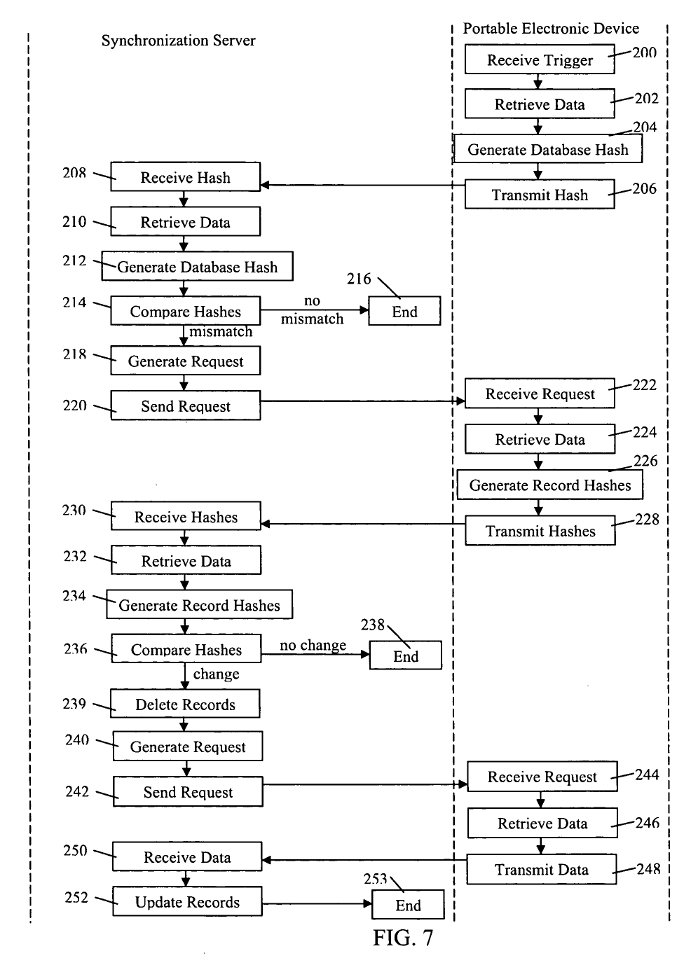

Reference is now made to FIG. 7 to describe the functions carried out at both the portable electronic device 22 and the communication system 20 during the special synchronization of databases connected by wireless interface. It will be understood that many of the steps described in relation to the special synchronization of FIG. 7 are similar to those steps described in relation to the synchronization of FIG. 4. Thus, where possible, the reference numerals used in describing the steps of FIG. 4 are raised by 100 in referring to similar steps carried out in the special synchronization steps of FIG. 5. Again, coding of software for carrying out the steps shown in FIG. 7 and described herein is well within the scope of a person of ordinary skill in the art.

First, the portable electronic device 22 receives the special synchronization trigger at 200. In response to receipt of the special synchronization trigger, data is retrieved from the databases 40, 42, 44 at step 202 and the processor 46 generates a database hash for each database 40, 42, 44 at step 204. After generation of each database hash, each database hash is transmitted along with an initialize command at step 206 to the communication system 20 over a radio communication channel. The initialize command initiates the special synchronization process at the synchronization server 30.

The communication system 20 receives the initialize command along with each database hash at step 208 by receipt at the base station 24 and forwards the database hashes on to the synchronization server 30. In response to receipt of each database hash from the portable electronic device 22, data is retrieved from the databases 34, 36, 38 at step 210 and the processor 62 of the synchronization server 30 generates a database hash for each respective database (referred to herein as the locally generated database hash) at step 212. After generation of each locally generated database hash, the hash information of each database hash received from the portable electronic device 22 is compared with the hash information of the corresponding locally generated database hash at step 214. If the comparison of the hash information indicates that the databases 40, 42, 44 of the portable electronic device 22 are not in mismatch with the respective databases 34, 36, 38 of the communication system 20, then the synchronization process ends at step 216. As indicated above, however, the special synchronization was triggered as a result of large changes to one or more of the databases 40, 42, 44 at the portable electronic device 22. In particular, the special synchronization was triggered as a result the deletion of a large number of data records at the portable electronic device 22. Thus, in the present case, the comparison of the hash information at step 214 results in the determination of a mismatch between at least one of the databases 40, 42, 44 of the portable electronic device 22 and the databases 34, 36, 38 of the communication system 20. Next, a request for record hash information is generated by the synchronization server 30 at step 218. The request for record hash information is a request for hash information associated with data records. The record hash information is requested for each data record of a particular database of the portable electronic device 22 that is determined to be mismatched with the corresponding database of the communication system 20. After generation of the request for record hash information, the request is then transmitted at step 220 to the portable electronic device 22.

Upon receipt of the request for record hash information at the portable electronic device 22 at step 222, data is retrieved from one or more of the databases 40, 42, 44 at step 224, in accordance with the request for record hash information. A record hash is then generated at step 226 for each of the data records of the respective database, and each record hash is transmitted at step 228 to the communication system 20 over the radio communication channel.

The record hash information is received at the communication system 20 and delivered to the synchronization server 30 at step 230. In response to receipt of the requested record hash information, data is retrieved from one or more of the corresponding databases 34, 36, 38 at step 232 and a record hash (referred to as the locally generated record hash) is generated for each data record of the respective database at step 234. After generation of each locally generated record hash, the record hash information received from the portable electronic device 22 is compared with the record hash information from each locally generated record hash at step 236 and a determination is made as to whether the data, of which the record hash information is representative, has changed. Thus, the record hash information generated from data records from one of the databases 40, 42, 44 of the portable electronic device is compared with corresponding record hash information generated from data records from the corresponding database 34, 36, 38 of the communication system 20. If it is determined that no changes have been made to a particular data record since the last synchronization, the synchronization process ends for the particular data record for which the data has not changed at step 238.

Thus, the processor 62 determines at step 236 what data records have changed and what, if any, data records at the communication system 20 do not exist at the portable electronic device 22. The comparison at step 236 results in the determination of data records deleted at the portable electronic device 22 that still exist at the communication system 20. The processor 62 also determines from the comparison at step 236 what, if any, additional or changed data records at the portable electronic device 20 are not reflected at the communication system 20. If it is determined that the data has changed at step 236, the databases are synchronized by updating the databases 34, 36, 38 at the communication system 20 only that are determined to be mismatched. Thus, the databases 34, 36, 38 at the communication system 20 are updated to match the databases 40, 42, 44 of the portable electronic device 22.

To update the databases 34, 36, 38, the data records determined to be present in any of the databases 34, 36, 38 that are not present in the databases 40, 42, 44 of the portable electronic device 22 are deleted at step 239. Thus, all records deleted from the portable electronic device 22 causing the special synchronization to be triggered are deleted from the databases 34, 36, 38. It will be understood that this special synchronization differs from normal synchronization described above in reference to FIGS. 4, 5A and 5B, in that the records present in the databases 34, 36, 38 on the communication system 20 side that are not present in the databases 40, 42, 44 of the portable electronic device 22, are not transmitted to the portable electronic device 22. Instead, these data records are deleted from the respective database of the communication system.

If it is determined at step 236 that additional data records or changes to data records at the portable electronic device 20 are not yet reflected at the communication system 20, a fetch request is generated by the synchronization server 30 as shown at step 240. After generation of the fetch request, the fetch request is transmitted to the portable electronic device 22 at step 242, thereby requesting data records added and changed on the portable electronic device 22 that have not been updated on the synchronization server 30.

The fetch request is then received at the portable electronic device 22 at step 244 and in response, the requested data records are retrieved from the databases 40, 42, 44 at step 246. After retrieving the data records, the retrieved data records are transmitted to the communication system 20 at step 248.

The requested data records are then received at the communication system 20 and delivered to the synchronization server 30 at step 250. In response to receipt of the requested data records, the respective ones of the databases 34, 36, 38 of the communication system 20 are updated by writing new data records or overwriting to update previously saved data records in the respective databases 34, 36, 38 at step 252. It will be understood that data records retrieved from one database of the portable electronic device 20 and transmitted to the communication device 20, are written to or overwritten on to the corresponding database of the communication system 20. Again, the special synchronization differs from the normal synchronization described above in reference to FIGS. 4, 5A and 5B, in that data records are updated in the databases 34, 36, 38 on the communication system 20 to reflect the data records in the databases 40, 42, 44 of the portable electronic device 22. The data records of the portable electronic device 22, however, are not changed. After a full comparison of each data record of each database determined to be in mismatch, the special synchronization ends.

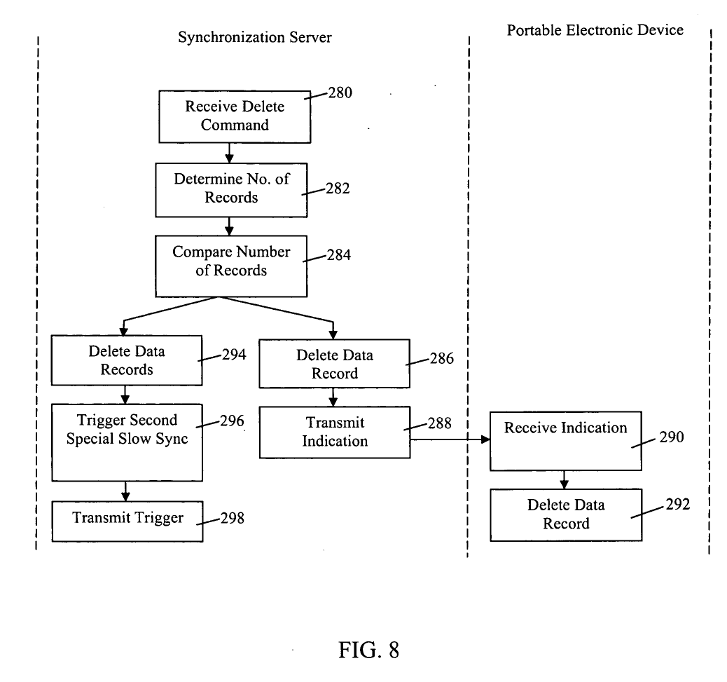

Reference is now made to FIG. 8 which shows a sequence diagram illustrating functions carried out at both the communication system 20 and the portable electronic device-22 when data records are deleted from the communication system. Coding of software for carrying out such steps is well within the scope of a person of ordinary skill in the art. First, the communication system 20 receives a delete data records command at step 280. After receiving the delete data records command, the processor 62 determines the number of data records to which the delete data records command relates at step 282. In other words, the processor 62 determines the number of data records to be deleted. Next the processor 62 compares the number of data records to which the delete data records command relates to a predetermined threshold value at step 284. If the number of data records to which the delete data records command relates is less than the threshold value, the data records to which the command relates are deleted from the database (or databases) 34, 36, 38 to which the data records belong at step 286 and a delete data record indication is transmitted to the portable electronic device 22 at step 288, for each data record deleted. Thus, for every data record deleted from the databases 34, 36, 38, a corresponding delete data record indication is transmitted to the portable electronic device 22.

The portable electronic device receives the delete data record indications at step 290 and deletes the respective data records from the respective database 40, 42, 44 at step 292.

If, on the other hand, the number of data records to which the delete data records command relates is greater than the threshold value, the data records to which the delete data records command relates are deleted from the database (or databases) 34, 36, 38 to which the data records belong at step 294 and the communication system 20 triggers a second special synchronization process at step 296 in which the databases 40, 42, 44 of the portable electronic device 22 are updated to mirror the databases 34, 36, 38 of the communication system 20. The communication system 20 transmits the second special synchronization trigger to the portable electronic device 22 at step 298.

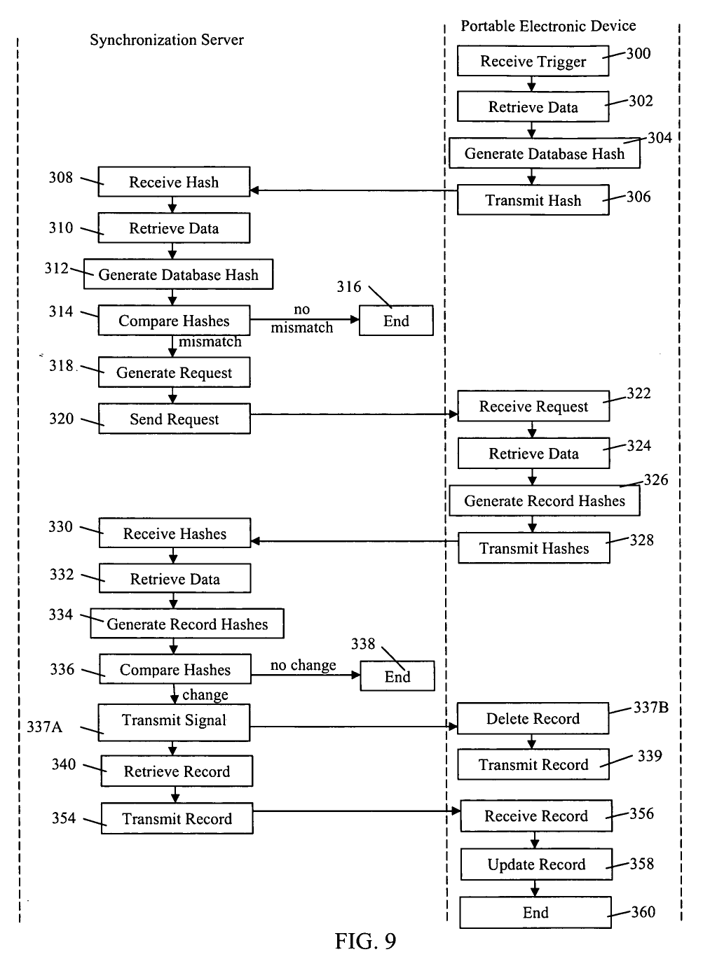

Reference is now made to FIG. 9 to describe the functions carried out at both the communication system 20 and the portable electronic device 22 during the second special synchronization of databases connected by wireless interface. It will be understood that many of the steps described in relation to the special synchronization of FIG. 9 are similar to those steps described in relation to the special synchronization of FIG. 7. Thus, where possible, the reference numerals used in describing the steps of FIG. 7 are raised by 100 in referring to similar steps carried out in the second special synchronization steps of FIG. 9. Again, coding of software for carrying out the steps shown in FIG. 9 and described herein is well within the scope of a person of ordinary skill in the art.

First, the portable electronic device 22 receives the second special synchronization trigger at 300. In response to receipt of the second special synchronization trigger, data is retrieved from the databases 40, 42, 44 at step 302 and the processor 46 generates a database hash for each database 40, 42, 44 at step 204. After generation of each database hash, each database hash is transmitted at step 306 to the communication system 20 over a radio communication channel.

The communication system 20 receives each database hash at step 308 by receipt at the base station 24 and forwards the database hashes on to the synchronization server 30. In response to receipt of each database hash from the portable electronic device 22, data is retrieved from the databases 34, 36, 38 at step 310 and the processor 62 of the synchronization server 30 generates a database hash for each respective database (referred to herein as the locally generated database hash) at step 312. After generation of each locally generated database hash, the hash information of each database hash received from the portable electronic device 22 is compared with the hash information of the corresponding locally generated database hash at step 314. If the comparison of the hash information indicates that the databases 40, 42, 44 of the portable electronic device 22 are not in mismatch with the respective databases 34, 36, 38 of the communication system 20, then the synchronization process ends at step 316. As indicated above, however, the second special synchronization was triggered as a result of large changes to one or more of the databases 34, 36, 38 of the communication system 20. In particular, the special synchronization was triggered as a result the deletion of a large number of data records from at least one of the databases 34, 36, 38. Thus, in the present case, the comparison of the hash information at step 314 results in the determination of a mismatch between at least one of the databases 40, 42, 44 of the portable electronic device 22 and the databases 34, 36, 38 of the communication system 20. Next, a request for record hash information is generated by the synchronization server 30 at step 318. The request for record hash information is a request for hash information associated with data records. The record hash information is requested for each data record of a particular database of the portable electronic device 22 that is determined to be mismatched with the corresponding database of the communication system 20. After generation of the request for record hash information, the request is then transmitted at step 320 to the portable electronic device 22.

Upon receipt of the request for record hash information at the portable electronic device 22 at step 322, data is retrieved from one or more of the databases 40, 42, 44 at step 224, in accordance with the request for record hash information. A record hash is then generated at step 326 for each of the data records of the respective database, and each record hash is transmitted at step 328 to the communication system 20 over the radio communication channel.

The record hash information is received at the communication system 20 and delivered to the synchronization server 30 at step 330. In response to receipt of the requested record hash information, data is retrieved from one or more of the corresponding databases 34, 36, 38 at step 332 and a record hash (referred to as the locally generated record hash) is generated for each data record of the respective database at step 334. After generation of each locally generated record hash, the record hash information received from the portable electronic device 22 is compared with the record hash information from each locally generated record hash at step 336 and a determination is made as to whether the data, of which the record hash information is representative, has changed. Thus, the record hash information generated from data records from one of the databases 40, 42, 44 of the portable electronic device is compared with corresponding record hash information generated from data records from the corresponding database 34, 36, 38 of the communication system 20. If it is determined that no changes have been made to a particular data record since the last synchronization, the synchronization process ends for the particular data record for which the data has not changed at step 338.

Thus, the processor 62 determines at step 236 what data records have changed and what, if any, data records at the portable electronic device 22 do not exist at the communication system 20. The comparison at step 336 results in the determination of data records deleted at the portable electronic device 22 that still exist at the communication system 20. The processor 62 also determines from the comparison at step 336 what, if any, additional or changed data records at the communication system 20 are not reflected at the portable electronic device 20. If it is determined that the data has changed at step 336, the databases are synchronized by updating the databases 40, 42, 44 at the portable electronic device 22 only. Thus, the databases 40, 42, 44 at the portable electronic device 22 are updated to match the databases 34, 36, 38 of the communication system 20.

To update the databases 40, 42, 44, for each of the data records determined to be present in any of the databases 40, 42, 44 that are not present in the databases 34, 36, 38 of the communication system 20, a record identifier is transmitted to the portable electronic device at step 337A. The record identifier acts as a signal to the portable electronic device during the second special synchronization, to delete the associated data record.

The portable electronic device 22 receives the record identifiers at step 337B and deletes the corresponding data records for which record identifiers are received, at step 339. Thus, all records deleted from the databases 34, 36, 38 of the communication system causing the special synchronization to be triggered, are deleted from the respective databases 40, 42, 44 of the portable electronic device 22. It will be understood that this second special synchronization differs from normal synchronization described above in reference to FIGS. 4, 5A and 5B, in that the records present in the databases 40, 42, 44 of the portable electronic device 22 that are not present in the databases 34, 36, 38 of the communication system 20, are not transmitted from the portable electronic device 22 to the communication system 20. Instead, these data records are deleted from the respective database of the portable electronic device 22.

If it is determined at step 336 that additional data records or changes to data records at the communication system 20 are not reflected at the portable electronic device 20, the data records that have been added or changed at the communication system 20 that have not been updated on the portable electronic device 22 are retrieved at step 340. These data records are then transmitted to the portable electronic device 22 at step 354.

The portable electronic device 22 receives the data records at step 356 and updates the data records at step 358 by writing the new data record or overwriting to update the previously saved data record in the respective database 40, 42, 44. Again it will be understood that the data records retrieved from one database of the communication system 20 and transmitted to the portable electronic device 22, are written to or overwritten on the corresponding database of the portable electronic device 22. After a full comparison of each data record of each database determined to be in mismatch and updating, the special synchronization ends.

Advantageously, rather than sending a large number of delete data record indications from the portable electronic device to the communication system when a large number of data records are deleted from the portable electronic device, a unidirectional synchronization process is triggered in which databases at only the communication system are changed to mirror the databases of the portable electronic device. During the unidirectional synchronization, data records present in the databases of the communication system that are not present in the databases of the portable electronic device, are deleted. Thus, there is no need to send a large number of delete data record indications. Instead, hash values are transmitted from the portable electronic device for comparison purposes, thereby saving transmission time and bandwidth.

Similarly, rather than sending a large number of delete data record indications from the communication system to the portable electronic device when a large number of data records are deleted from the communication system, a second unidirectional synchronization is triggered in which databases at only the portable electronic device are changed to mirror the databases of the communication system. During the second unidirectional synchronization, data records present in the databases of the portable electronic device that are not present in the databases of the communication system, are deleted. Thus, there is no need to send a large number of delete data record indications. Instead, hash values are transmitted from the communication system for comparison purposes and in response to the comparison, only an identifier of the records to be deleted is transmitted to the portable electronic device, thereby saving transmission time and bandwidth.

While the special synchronization has been described as being triggered when a threshold number of data records to which a delete data records command relates, is exceeded, the special synchronization is not limited to triggering by a delete data records event. Rather, other events in which the data records of at least one of the databases 40, 42, 44 of the portable electronic device 22 are changed can trigger the special synchronization as described with reference to FIG. 7. For example, the data records of the databases 40, 42, 44 of the portable electronic device 22 can be modified by serial connection of the portable electronic device 22 to, for example, a computing device such as a desktop computer for serial synchronization with corresponding databases of the computing device, as will be understood by those skilled in the art. Thus, changes are made to the data records of the databases 40, 42, 44 by adding data records, modifying data records and restoring data records on the portable electronic device 22, to reflect the data records in the corresponding databases of the computing device. The changes made to the data records on the portable electronic device 22 are not transmitted to the communication system 20 during the serial synchronization process. Thus, upon completion of the serial synchronization process, changes made to the data records of the portable electronic device 22 are not reflected in the data records of the communication system 20. To synchronize the databases 40, 42, 44 of the portable electronic device 22 with the databases 34, 36, 38 of the communication system, the special slow synchronization as described with reference to FIG. 7, is triggered when the serial connection between the portable electronic device 22 and the computing device is terminated (disconnected). The data records are thereby updated in the databases 34, 36, 38 of the communication system 20 to reflect the data records in the databases 40, 42, 44 of the portable electronic device 22. The data records of the portable electronic device 22, however, are not changed during the special synchronization.

While the embodiments described herein are directed to particular implementations of the method and apparatus for synchronizing databases connected by wireless interface, it will be understood that modifications and variations to this embodiment are within the sphere and scope of the present application. For example, other events can trigger the special synchronization. Any change in data records on the portable electronic device 22 in which it is desirable to synchronize the databases 40, 42, 44 of the portable electronic device 22 with the databases 34, 36, 38 of the communication system 20 by changing databases on only the communication system 20-to mirror the databases of the portable electronic device 22, can trigger the special synchronization. Similarly, any change in data records of the communication system in which it is desirable to synchronize the databases 34, 36, 38 of the communication system 20 with the databases 40, 42, 44 of the portable electronic device 22, by changing the databases on only the portable electronic device 20 to mirror the databases of the communication system 22, can trigger the second special synchronization.

Other modifications and variations are also possible. It will be understood that the portable electronic device is not limited to three databases as any suitable number of databases is possible. Similarly, the communication system may include any suitable number of databases. Although the special synchronization described above includes the updating of added or changed records in the databases of the communication system to reflect added or changed records in the databases of the portable electronic device, it will be appreciated that the special synchronization can include only the deletion of records in the databases of the communication system that are not present in the databases of the portable electronic device. Similarly, the second special synchronization can include only the deletion of records in the databases of the portable electronic device that are not present in the databases of the communication system.

Many other modifications and variations may occur to those skilled in the art. All such modifications and variations are believed to be within the sphere and scope of the present application.

1. A method of synchronizing a first database including first data records with a second database including second data records, the method comprising:
receiving information representative of said second data records;
comparing information representative of the first data records with the information representative of the second data records of the second database; and
modifying said first data records of the first database, said modifying including deleting ones of said first data records present in said first database for which there is no corresponding second data record present in said second database.

2. The method according to claim 1, comprising receiving a synchronization trigger along with said information representative of said second data records.

3. The method according to claim 1, wherein modifying the first data records of the first database further includes writing to the first database further data records corresponding to second data records present in the second database for which there is no corresponding first data record present in said first database.

4. The method according to claim 3, wherein modifying the first data records of the first database further includes for those first data records that differ from corresponding ones of the second data records, overwriting those first data records of the first database to reflect the corresponding ones of the second data records.

5. The method according to claim 1, wherein comparing information representative of the first data records with the information representative of the second data records includes determining if a corresponding second data record is present in said second database for each first data record in the first database, prior to modifying said first data records.

6. The method according to claim 5, wherein said comparing includes for each second data record, determining whether or not a corresponding first data record exists in the first database and, if not requesting transmission of the second data record for which no corresponding first data record exists.

7. The method according to claim 1, wherein said comparing further includes determining if other first data records differ from corresponding other ones of the second data records and, if so, requesting transmission of the other ones of the second data records.

8. The method according to claim 5, further comprising receiving said second data record and writing to the first database.

9. The method according to claim 7, further comprising receiving the other ones of the second data records and overwriting over respective ones of the other first data records.

10. The method according to claim 1, wherein said receiving information representative of the second data records comprises receiving hash information representative of said second data records.

11. The method according to claim 10, wherein said comparing comprises comparing said hash information representative of the second data records with corresponding hash information representative of the first data records.

12. The method according to claim 2, wherein said synchronization trigger is generated at an electronic device on which said second database resides, in response deleting ones of the second data records.

13. The method according to claim 2, wherein said synchronization trigger is generated at an electronic device on which said second database resides, in response to receiving a delete data records command for deleting ones of the second data records, comparing the number of the ones of the second data records with a threshold number, and determining that the number of the ones of the second data records exceeds said threshold number.

14. An apparatus for synchronizing a first database including first data records with a second database including second data records, the apparatus comprising:
a memory device for storing said first data records in said first database;
a processor operably coupled to said memory device and to a transmitting and receiving device, for receiving information representative of said second data records, comparing information representative of the first data records with the information representative of the second data records of the second database, and modifying said first data records of the first database, said modifying including deleting ones of said first data records present in said first database for which there is no corresponding second data record present in said second database.

15. A computer-readable medium having computer-readable code embodied therein for execution by a processor for:
receiving information representative of second data records of a second database;
comparing information representative of first data records of a first database with the information representative of the second data records of the second database; and
modifying said first data records of the first database, said modifying including deleting ones of said first data records present in said first database for which there is no corresponding second data record present in said second database.
